(19) United States
(12) Patent Application Publication
(10) Pub. No.: US 2022/0164442 A1
(43) Pub. Date: May 26, 2022

(54) THREAD MAPPING

(71) Applicant: Hewlett-Packard Development Company, L.P., Spring, TX (US)

(72) Inventors: Christopher Ian Dalton, Bristol (GB); Maugan Villatel, Bristol (GB); Pierre Belgarric, Bristol (GB)

(73) Assignee: Hewlett-Packard Development Company, L.P., Spring, TX (US)

(21) Appl. No.: 17/602,305

(22) PCT Filed: Aug. 12, 2019
(86) PCT No.: PCT/US2019/046210

§ 371 Date: Oct. 8, 2021

(51) Int. Cl. G06F 21/55; G06F 21/71; G06F 9/38; G06F 9/30; G06F 9/50

(52) U.S. Cl. CPC G06F 21/556; G06F 21/71; G06F 9/5027; G06F 9/3851; G06F 9/3009; G06F 9/3842

(57) ABSTRACT

There is provided a method for thread allocation in a multi-processor computing system. The method includes determining whether a thread for execution has a security requirement. The thread is allocated to one of a first processing unit or a second processing unit based on the determination. The thread is allocated for execution by the first processing unit based on the thread having the security requirement.

### BACKGROUND

Modern processor designs obtain improved performance by using increasingly complex microarchitectures that enable parallel execution of microcode instructions at the microarchitectural level. For example, this can be achieved by having ever deeper pipelines and increasing the number of pipelines (i.e. super-scaling). When using such processor architectures many instructions are typically in the process of being executed at the same time. To maximise the utilisation of the processor, some instructions that rely on a result from a preceding instruction are speculatively executed based on an assumption as to what the outcome from the preceding result will be. The execution of the later instruction is performed based on the assumption. However, if the assumption proves to be false, the instructions that relied upon these assumptions for correctness need to be discarded. These discarded instructions, even if never committed modify the state of the microarchitecture—i.e. by modifying the cache memory of the processor.

Such microarchitectures have been shown to be vulnerable to so-called transient execution attacks that rely on rolling back or discarding of executed instructions that have not been committed yet i.e. instructions that have been executed at the microarchitectural level (e.g. leaving a trace by modifications to the cache), but have not been committed at the architectural level (e.g. to the registers or other architectural elements). Two broad examples of such attacks are ‘Spectre’ like attacks that exploit speculative execution (e.g. branch prediction or indirect branching), and ‘Meltdown’-like attacks that exploit processor-specific exceptions such as speculatively executed instructions being allowed to bypass memory protection. Some such attacks may involve mis-training the processor so that it will later make an erroneous speculative prediction which can be exploited by an attacker. Other attacks manipulate the cache state to remove data that a processor would need to make decisions at conditional branches. Attacks that exploit indirect branches may mis-train a branch target buffer (BTB) to address a malicious fragment of code (sometimes called a ‘gadget’). ‘Meltdown’ attacks exploit a processor specific exception in that allowed for out-of-order instructions to read all memory regions that were readable by the operating system (O/S) kernel when a user space was running (i.e. code that runs outside the O/S kernel). For example, certain versions of the Linux O/S had a kernel-only region that maps the entire physical memory, it meant a program could read the entire physical memory using such a ‘Meltdown’-type attack.

### BRIEF DESCRIPTION OF THE DRAWINGS

Various features and advantages of certain examples will be apparent from the detailed description which follows, taken in conjunction with the accompanying drawings, which together illustrate, by way of example, a number of features, and wherein:

FIG. 1 is a block diagram of computer hardware according to an example;

FIG. 2 is a block diagram of a thread scheduler according to an example;

FIG. 3 is a flowchart of a method for thread allocation according to an example;

FIG. 4 is a block diagram of a processor and a memory according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

As mentioned above, complex microprocessor architectures may be susceptible to transient-execution attacks or other attacks that take advantage of processor optimization techniques. Patching existing vulnerable processors has proven to be of limited value because closing the vulnerability often means removing the vulnerable optimization technique, which has a significant adverse impact on performance. In other words, such a patch may impose a significant toll on all executed code if applied, and leaves the door open to an attack if not applied. This makes the application of a generic solution difficult as users may favour security vs. performance differently, and may require a non-expert user to make a choice as to whether a patch should be applied without fully understanding of the threat.

In an example, there is a method for thread allocation in a multi-processor (e.g. heterogeneous) computing system. A multi-processor computing system being a computing system with two or more processors or processor cores (sometimes call execution units) for executing code. The method determines whether a thread for execution has a security requirement and allocates the thread to one of a first processing unit or a second processing unit based on the determination. In the method, the thread is allocated for execution by the first processing unit based on the thread having the security requirement.

A thread may have a security requirement if it relates to code that is untrusted or risky (i.e. because the source is unknown or not trusted). Such code may be a security risk as it may potentially contain malicious code that attempts to exploit the vulnerabilities in processor architectures. Alternatively, or additionally, the security requirement may arise because the thread is executing sensitive code. In other words, code which upon execution relates to sensitive functionality (e.g. cryptographic tasks) or security sensitive data that the user would not want leaked to an attacker.

By necessarily allocating threads based on having a security requirement to a first processing unit, security sensitive threads are effectively sandboxed at an individual processing (execution) unit. Non-sensitive and trusted code can be executed elsewhere from the threads with a security requirement while the performance advantages of executing threads using processors with micro-architectural optimisations. In the case of sensitive code, keeping sensitive code at one processing unit would reduce the risk of micro-architectural side-channel interference from other executing code on that processing unit. In an example, the untrusted code might be executed at one processing unit and the sensitive code executed at another processing unit.

The first processing unit and second processing unit may be a single or multi-core execution unit or processor. In an example, the first processing unit may be a first core of a multi-core processor and the second processing unit may be a second core of the multi-core processor. The processing units may have a single mode of operation (i.e. not have different security modes). The first and second processing units may be a same processor or a processor having a same or similar micro-architectural complexity and/or processing capability.

In an example, the method is performed using heterogenous hardware where some processors use aggressive microarchitectural optimization to maximise performance, while other processors are simpler. The more complex processors are vulnerable to transient execution attacks whereas processors having the simpler microarchitectures are less vulnerable. In some cases, it may also be possible for a particular processor to having multiple cores that are not identical such that one core uses a simpler microarchitecture and another a more complex architecture. For example, in a multi-processor core it may be possible to statically or dynamically reconfigure the microarchitecture of a core, e.g. with a micro-code patch or similar, so as to create a simpler “dumbed down” core in the processor that is less vulnerable to attacks. This allows for maximum performance for processes and threads that are not security sensitive, and allows for sensitive or suspicious processes to be exclusively run in a processing environment that is not vulnerable (or least less susceptible) to a transient execution attack (at a performance cost). The processing (execution) units, in an example, would be processor cores that implement a same instruction set. The system software could be configured to map processes to appropriate cores depending on the need for security versus performance by basing the allocation on whether the thread has a security requirement.

For example, a digital security policy could be used to map or allocate the threads. Such a policy in general sense defines a set of constraints on the behaviour of a computer system in accordance with pre-defined rules of behaviour that are deemed to be secure for the computer system. The policy would provide rules to decide on the need for security or performance and the thread would be allocated to the less vulnerable processor (secure execution unit), to the performant (higher performance processor) or to either. In an example, energy or power consumption may also be used in the thread allocation. In other words, low priority processes or threads may be executed on the simpler processing unit in order to reduce power consumption (regardless of security). The policy may be set explicitly by a user or an administrator of the system, or could at least be provided with high-level directives to direct the thread allocation decision making. The policy could be applied or define autonomously by the computing system. For example, by inspecting the thread for properties or micro-code that indicates that it should have a security requirement. In an example, the property is that the thread includes instructions or processes that relate to a security sensitive function (e.g. cryptographic function) or a metric indicating suspicious behaviour (e.g. atypically requests to access the cache with a high number of cache misses).

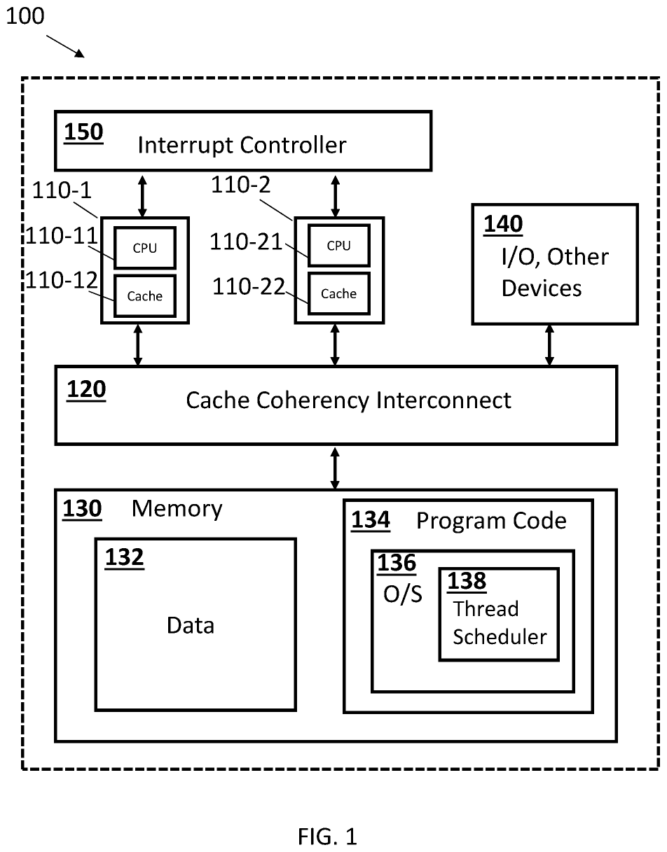

FIG. 1 shows a computing system, according to an example, including a first processor 110-1 and a second processor 110-2. The first and second processors 110-1, 110-2 both include a CPU 110-11, 110-21 and a cache memory 110-12, 110-22. The cache memory 110-12, 110-22 of one or each processing unit may be a multi-level cache (e.g. L1 & L2 cache). The processors are communicatively coupled to a cache coherency interconnect 120. The system has a main memory 130 which is communicatively coupled to the processing units 110-1 and 110-2 via the cache coherency interconnect unit 120. Other devices and I/O units communicate with the processing units 110-1, 110-2 via the cache coherency interconnect. An interrupt controller 150 is also communicatively couple to the processing units 110-1 and 110-2 to allow interrupts to be migrated between processing units.

The processing unit caches 110-12 and 110-22 are provided to bridge the gap between the faster processing unit registers and the slower main memory 130. The cache memory will contain copies of data from the main memory. The cache here is shown as a single cache unit but in examples the cache may comprise a hierarchy of successively smaller but faster cache memories. These are sometimes referred to as cache levels where L1 denotes the level 1 cache at the top of the hierarchy. Upon needing data from memory, the CPU will check the cache first starting at the L1 cache at the top of the hierarchy and moving through any other cache levels e.g. L2. In an example (not shown), the processing units may share a level 3 (L3) cache memory, sometimes called a Last-Level Cache (LLC). If the requested data is not in the cache it has to then be retrieved from the main memory. The retrieved value is typically copied to the cache so that it can be reused. The logic being that a recently obtained piece of data is likely to be used again in the near future and so should remain rapidly available for subsequent data requests. Obtaining the value from main memory takes a significant number of clock cycles, however, and it is during the wait for the return of data from main memory that some out-of-order execution of micro-instructions in a thread may occur and be exploited in a transient execution attack. Other techniques are possible to exploit the memory hierarchy to carry out transient execution attacks, however. For example, data present in a L1 cache may be targeted during the time it takes to retrieve data from an L3 cache (rather than main memory).

The processing units 110-1, 110-2 need to ensure the consistency of their respective cache memories 110-12, 110-22. The cache coherency interconnect 120 maintains coherency between caches of different processing units 110-1, 110-2 according to a cache coherency protocol. For example, the MESI protocol or a variant may be used. An example of a coherency operation would be to have a memory write operation on one cache 110-12, 110-22 will cause copies of the same data in the cache of other processing units 110-12, 110-22 to be marked or flagged as invalid.

In the example shown in FIG. 1, the CPU of the first processing unit 110-1 is simpler than the CPU of the second processing unit e.g. at the micro-architectural level. That is to say, for example, that CPU 110-11 does not permit out-of-order execution or speculative execution. This may be due to the CPU 110-11 having a smaller buffer or pipeline or reduced number of instruction execution pipelines when compared with CPU 110-21. The CPU 110-11 will, therefore, typically be slower or have less performance that the CPU 110-21 of the second processing unit. By contrast, the CPU 110-21 may use micro-architectural optimisations such as extensive pipelining (e.g. superscaling) and speculative execution to improve its performance. The disadvantage being that these optimisations make the CPU 110-21 of the second processing unit 110-2 more vulnerable to transient execution attacks or other attacks which exploit micro-architectural complexity. In an example, the CPU 110-11 and the CPU 110-21 have a same or similar instruction set. This makes it simpler to allocate threads as in principle either processor could execute any thread for execution that is to be allocated. In an example, the first processing unit is an ARM Cortex A7 and the second processing unit an ARM Cortex A15 processor.

The main memory 130 may include one or multiple RAM modules, for example double data rate (DDR) memory or other suitable memory known to those skilled in the art. Data 132 and executable program code 134 reside in areas of the memory 130. The program code may include executable code for instantiating an operating system (O/S) 136 running a thread scheduler 138. The thread scheduler 138 may be part of the kernel of the O/S 136, for example, and controls the timing and provision of program threads of applications executing upon the O/S platform. Multi-threading of application software is possible within most modern operating systems, Applications (or more generally computer programs) contain one or multiple sets of instructions for performing certain processes or tasks. The corresponding sets of instructions for a process or task of the application software may be executed as different threads. The thread scheduler generally determines which thread should next be provided processor time at each processing unit 110-1, 110-2 in a particular time slice or, where the or each processing unit has multiple cores, at the individual cores of the processing units 110-1, 110-2. Certain threads may be prioritised by the scheduler 138 such that a thread with higher priority may receive more processor time than a thread with a lower priority. For example, where there are three threads and two processing units 110-1, 110-2 and one of those threads has higher priority, it may be allocated more processing time at the available processing units. The scheduler 138 may further determine which processing unit 110-1, 110-2 is to be selected for executing the thread and the thread allocated (or mapped) accordingly. As will be explained further below, the allocation, according to an example, may alternatively or additionally be based (at least partly) on whether a thread to be executed has a security requirement such as relating to risky or untrusted code, or to handling sensitive data.

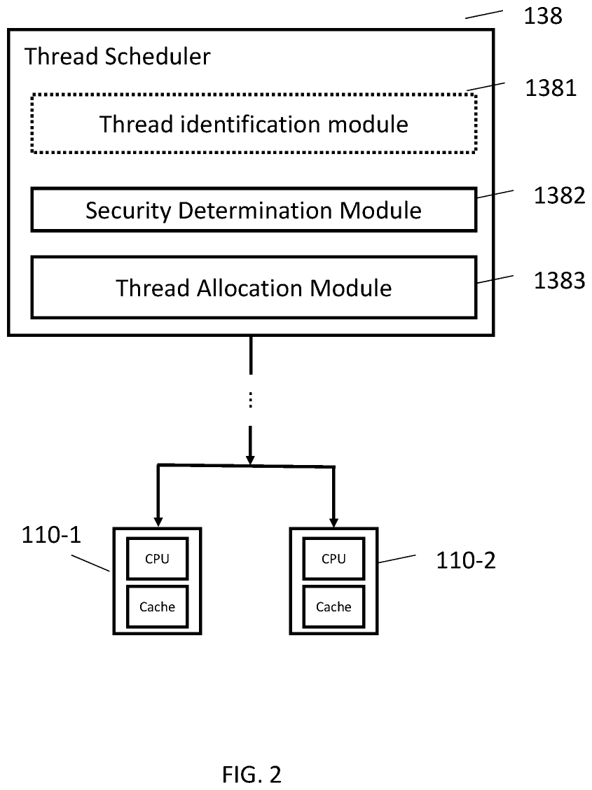

In an example, the thread scheduler 138 is as shown in FIG. 2. The thread scheduler 138 comprises a thread identification module 1381, a security determination module 1382 and a thread allocation module 1383. The thread scheduler 138 controls the allocation of the threads to the processing units 110-1 and 110-2 via the cache coherency interconnect 130. The thread identification module 1381 is to identify one or more properties of a thread which are relevant to its scheduling or allocation. The security determination module 1382 is to determine if the thread has a security requirement. The thread allocation module 1383 is to allocate the thread to one of the first or second processing units 110-1, 110-2. The allocation, according to an example, being based of the determination of whether the thread for execution has the security requirement or not.

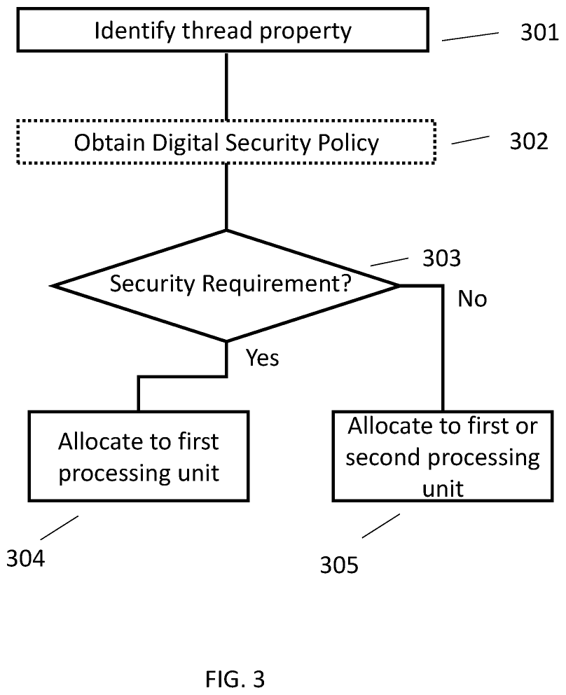

The operation of the thread scheduler will now be explained by reference to the example process performed in the blocks of the flow chart of FIG. 3. At block 301, a property of a thread is identified. The identification may take place by a process of thread inspection by the O/S. In an example, the property may be identified as the application to which the thread is associated. In another example, the property may be the application type or whether the thread is executing on a VM or a scripting language running within an application. For example, if the application or program relates to accessing secure information using passwords or cryptographic techniques or not. Another property might be the source of the program or application that is associated with the thread. For example, whether the source is from the internet from an untrusted source or trusted source. An example would be the case of a web browser. A web browser generally requires good performance but also executes some code which could be deemed untrusted (e.g. JavaScript) that could be used to carry out microarchitectural attacks such as transient execution attacks (‘Spectre’ etc). A property could therefore by whether the thread relates to JavaScript executing on a Web Browser.

Another property might be whether the code contains a sequence of instructions associated with a security sensitive process such as a cryptographic process, or a process that requires low level system calls to the kernel of the O/S 136. The sequence of instructions might be identified as including certain instruction sets such as conditional branching or indirect addressing e.g. instruction sets that would be exploitable by microarchitectural attacks. In another example, the property might relate to behaviour of the thread or process during current or previous execution and whether that is indicative of suspicious activity. For example, a high number of cache misses (instances where a request for data from the cache fails and the data has to be retrieved from main memory) of an executing thread might be an indicator of interest regarding whether the thread is a threat. In that case, it might be desirable to re-target the thread by allocating it to a secure processing unit such as the first processing unit 110-1. In another example, the thread (which comprises a sequence of instructions) may contain data within the binary code of the compiled thread that provides information about its need for performance or security to the system. Such data could be defined by the developer of the software, the distributor, or at installation time (e.g. based on characteristics of the computing system on which the software is being installed).

Optionally, at block 302, a digital security policy may be obtained which is to be used to determine whether the thread has a security requirement using the identified properties of the thread. The digital security policy may be obtained from storage or memory by the security determination module. The properties of the digital security policy may be set by an administrator or may be pre-determined by the O/S 136. Alternatively, or additionally, a user may be able to manually configure the security policy according to their requirements and attitude to security risks. The security policy may take the form of a look-up table, that maps certain thread properties to whether a thread has a security requirement or not.

| Thread Property | Security Requirement? |
|---|---|
| Web browser-JavaScript | Yes |
| Graphics processing task | No |
| Audio processing task | No |
| Risky instruction sequence | Yes |
| Document processing application | No |
| Password management software | Yes |
| Low level task | Yes |
| Cryptographic task | Yes |
| Encoding or Decoding task | Yes |
| Distributed computing task | Yes |

At block 303, a determination is made as to whether the thread has a security requirement. The determination may be made by the security determination module 1382. One way of making the determination is to use the obtained digital security policy. The thread property or properties identified at block 301 may be used to address the look-up table and determine whether the thread is deemed to have a security requirement. Alternatively, in the case where a digital security policy is not used, the property or properties identified at block 301 may be used directly according to rules set by the O/S so as to autonomously determine security risks or sensitive code. For example, the thread may be flagged as having a security requirement if the thread is identified as having the property that it contains un-trusted or sensitive code. Similarly, in the case where the behaviour of the thread such as a high number of cache misses has been identified as a property, this might necessitate that the thread has a security requirement and needs to be re-targeted to a secure execution environment. Further, the property may be that the thread contains data in the binary of the thread code indicating that security or performance is to be prioritised and a security requirement may be determined accordingly.

If the determination at block 303 determines that there is a security requirement for the thread then based on that determination, the thread is allocated at block 304 to the first processing unit. In contrast, if the determination is that there is no security requirement, the thread is allocated to either of the first or second processing units 110-1, 110-2.

In the example, above the allocation is based on the security requirement but as already mentioned the scheduler 138 may additionally take into account the performance or energy requirements of a thread. For example, a thread identified as relating to graphics processing might have no security requirement, but it is likely to have a high-performance requirement so the scheduler 138 will take this into account and allocate it to the second (higher performance) processing unit 110-2 where possible. By contrast, a thread identified as relating to a document processing task may have no security requirement according to the example security policy table above. However, the document processing task is unlikely to be processor intensive and accordingly may have no or a low performance requirement, so the scheduler is free to allocate it to either the first or second processing unit 110-1, 110-2.

In another example, threads without a security requirement are allocated by the scheduler 138 to the second processing unit 110-2 but not the first processing unit 110-1. In that way there is a stricter sandboxing of risky code and allows all non-risky code threads to be processed with optimum performance. In an example, the system 100 may contain more than two processing units 110-1, 110-2. According to an example, the system may have multiple high-performance processing units and a smaller number of low performance processing units for the secure execution. For example, there might be only a single secure execution processing unit (first processing unit 110-1) for to which threads with a security requirement are allocated to and multiple higher complexity/performance processing units (second processing unit(s) 110-2).

In another example, the scheduler 138 may be allowed to make exceptions to a rule that a thread with a security requirement has to be allocated to the first processing unit 110-1. In particular, in the case where the first processing unit is fully occupied an exception may be made that allows the scheduler 138 to allocate the thread to the second processing unit 110-2 despite the security requirement. This might be mandated by the security policy or the CPU such that certain types of tasks which represent a medium security risk are permitted in the exceptional circumstances to the be executed on the second processing unit 110-2. In contrast, it may be mandated that processes with a security requirement that indicates a high security risk are always allocated to the first processing unit 110-1 even where this will result in a delay to execution of a thread due to it being alternately scheduled with other threads with security requirements or waiting for completion of another risky thread by the first processing unit 110-1

As mentioned previously, examples are not limited to the first and second processing units 110-1 and 110-2 being single CPU (core) processors. One or both may be multi-core processors. Further, the schedule 138 may be arranged to allocate on a core-by-core basis or a processor-by-processor or both, depending on the performance and security needs of the computer architecture.

In an example the arrangement of units of the system shown in FIG. 1 may be formed as components on a PCB or other circuitry. Alternatively, the units may be grouped and formed on at least one ASIC, FPGA or other circuit blocks. For example, at least the processing units 110-1, 110-2, interrupt controller 150, and the cache coherency interconnect 120 may be composed on a single chip as an ASIC or FPGA. According to another example, each processing unit is formed on a different ASIC.

An advantage of examples mentioned above is that microarchitecture optimizations may be leveraged, while not impacting security for security sensitive threads. The examples make reasonable assumptions, as an increasing number of platforms/processors present multiple execution units/cores for allocation/mapping of threads. Chip designers have been increasingly relying on multi-core processor or acceleration execution units. In addition, there is an increasing focus on energy consumption, which has led to heterogeneity of execution units, with performant processing units aside low-energy processing units. This makes it viable to integrate the systems and methods described above in contemporary hardware.

From a software standpoint, the described methods are an evolution of thread scheduling to take into account the specificity of the execution units and the security requirements of threads. This provides additional flexibility and security functionality to spatial scheduling on heterogeneous hardware or a “core scheduler” of Hyper-V (if hyperthreading is enabled, ensures that “sibling” logical CPUs should never run different VMs, thus reducing the chance of VM-to-VM microarchitectural attacks).

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus, modules of apparatus (for example, a rendering device, printer or 3D printer) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine readable instructions may also be stored in a computer readable storage that can guide the computer or other programmable data processing devices to operate in a specific mode.

For example, the instructions may be provided on a non-transitory computer readable storage medium encoded with instructions, executable by a processor.

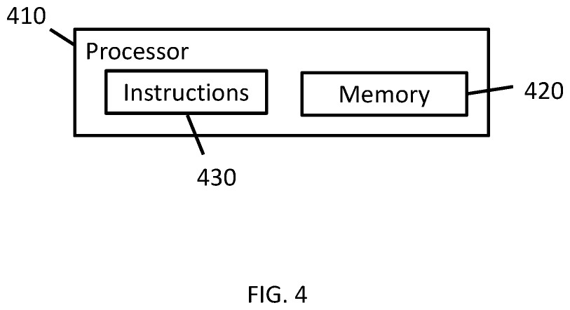

FIG. 4 shows an example of a processor 410 associated with a memory 420. The memory 420 comprises computer readable instructions 430 which are executable by the processor 410. The instructions 430 comprise:

Instructions to determine whether a thread for execution has a security requirement

Instructions to allocate the thread to one of a first processing unit or a second processing unit based on the determination. The instructions allocate the thread for execution by the first processing unit based on the thread having the security requirement.

According to an example, the first processing unit has a lower performance than the second processing unit.

According to an example, the micro-architecture of the first processing unit is simpler than the second processing unit. For example, the pipeline architecture implemented in the first processing unit may be simpler than in the second processing unit.

According to an example, the thread is determined as having a security requirement if it relates to un-trusted code or sensitive code.

According to an example, the thread includes code relating to security data which upon inspection allows the determination to be made.

According to an example, the determination is made according to a digital security policy. The digital security policy may be configured manually. According to an example, the digital security policy may be applied autonomously by inspecting a thread for a property that indicates that it has a security requirement.

In an example, the property includes any of an instruction or group of instructions relating to a security sensitive function, or a metric indicating suspicious activity by the thread. For example, the metric may be that the thread causes a high number of cache misses.

Such machine readable instructions may also be loaded onto a computer or other programmable data processing devices, so that the computer or other programmable data processing devices perform a series of operations to produce computer-implemented processing, thus the instructions executed on the computer or other programmable devices provide a operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for thread allocation in a multi-processor computing system, the method comprising:
determining whether a thread for execution has a security requirement
allocating the thread to one of a first processing unit or a second processing unit based on the determination, wherein the thread is allocated for execution by the first processing unit based on the thread having the security requirement.

2. A method according to claim 1, wherein the first processing unit has a lower performance than the second processing unit.

3. A method according to claim 1, wherein the micro-architecture of the first processing unit is simpler than the second processing unit.

4. A method according to claim 1 wherein the first and second processing units use a same or similar instruction set.

5. A method according to claim 1, wherein the thread is determined as having a security requirement if it relates to un-trusted code or sensitive code.

6. A method according to claim 1, wherein the thread includes code relating to security data which upon inspection allows the determination to be made.

7. A method according to claim 1, wherein the determination is made according to a digital security policy.

8. A method according to claim 7, wherein the digital security policy is applied autonomously by inspecting a thread for a property that indicates that it has a security requirement.

9. A method according to claim 8, wherein the property includes any of an instruction or group of instructions relating to a security sensitive function, or a metric indicating suspicious activity by the thread.

10. Apparatus comprising one or more processors configured to:
determine whether a thread for execution has a security requirement;
allocate the thread to one of a first processing unit or a second processing unit based on the determination, wherein the thread is allocated for execution by the first processing unit based on the thread having the security requirement.

11. Apparatus according to claim 10, wherein the first processing unit has a lower performance than the second processing unit.

12. Apparatus according to claim 10, wherein the thread is determined as having a security requirement if it relates to un-trusted code or sensitive code.

13. Apparatus according to claim 10, wherein the thread includes security data which allows the determination to be made.

14. Apparatus according to claim 10, wherein the determination is made according to a digital security policy.

15. A non-transitory machine-readable storage medium encoded with instructions executable by a processor, the machine-readable storage medium comprising instructions to:
determine whether a thread for execution has a security requirement;
allocate the thread to one of a first processing unit or a second processing unit based on the determination, wherein the thread is allocated for execution by the first processing unit based on the thread having the security requirement.
